(19) United States
(12) Patent Application Publication
(10) Pub. No.: US 2026/0170754 A1
(43) Pub. Date: Jun. 18, 2026

(54) PHOTOREALISTIC 3-D SCENE RECONSTRUCTION AND DISTRIBUTION PLATFORM

(71) Applicants: Sony Group Corporation, Tokyo (JP); Sony Pictures Entertainment Inc., Culver City, CA (US)

(72) Inventors: Nikola Dordic, Vancouver (CA); Lukas Bauer, Toronto (CA); Dusan Svilarkovic, AP Vojvodina (RS); Mahmoud Rahnama, Toronto (CA); Michal Pawlowski, Warsaw (PL)

(21) Appl. No.: 19/186,402

(22) Filed: Apr. 22, 2025

Related U.S. Application Data
(60) Provisional application No. 63/734,553, filed on Dec. 16, 2024.

(51) Int. Cl. G06T 17/00; G06T 15/00

(52) U.S. Cl. CPC G06T 17/00; G06T 15/005

(57) ABSTRACT

A scene reconstruction method using image-based data, including: data ingesting and pre-processing of the image-based data entered by a user, wherein the pre-processing includes receiving one of video frames or image sequences of the image-based data and interactively scrubbing one of the video frames or image sequences; selecting specific frames or sequences of the video frames or image sequences for scene reconstruction; distributed processing of the selected frames or sequences using resource allocation, load balancing, priority-based job queuing, real-time progress monitoring, and interactive progress visualization and status reporting; real-time viewing and editing of the selected frames or sequences to generate photorealistic and editable 3-D scenes, wherein the real-time viewing and editing uses real-time scene exploration and manipulation, camera control and trajectory planning, and arbitrary output variables (AOV) preview capabilities.

### CROSS-REFERENCE TO RELATED APPLICATIONS

This application claims the benefit of priority under 35 U.S.C. § 119(e) of co-pending U.S. Provisional Patent Application No. 63/734,553, filed Dec. 16, 2024, entitled “Photorealistic 3-D Scene Reconstruction and Distribution Platform”. The disclosure of the above-referenced application is incorporated herein by reference.

### BACKGROUND

### Field

The present disclosure relates to 3-D scene reconstruction, and more specifically to 3-D scene reconstruction using image-based data.

### Background

There may be situations where it is useful to obtain a virtual reconstruction of a physical environment including generating a digital representation such as a 3-D model that corresponds to the physical environment. Existing approaches to generate such a representation may utilize data obtained by scanning such an environment, but these existing approaches are not able to transform image-based data into photorealistic, editable 3-D scenes using existing reconstruction techniques.

### SUMMARY

The present disclosure provides for 3-D scene reconstruction using image-based data.

In one implementation, the term “image-based data” refers to every 2-D visual asset the user supplies to the platform including single photographs (RAW, JPEG, PNG, EXR), video files or extracted frames (MP4, MOV), multi camera image sets, and any derived 2-D outputs such as depth or normal maps generated during preprocessing.

In one implementation, “captured data” is the umbrella term for everything produced in the field, including all image-based data plus sensor metadata (intrinsics, focal length, exposure, GPS, IMU, timestamps) and any auxiliary logs or rig calibration files.

In one implementation related to the web application, the term “input media” refers to a portion of the captured data that a user uploads into a project. The project layer stores and tracks this media alongside parameter settings and reconstruction results.

In one implementation, a scene reconstruction method using image-based data is disclosed. The method includes: data ingesting and pre-processing of the image-based data entered by a user, wherein the pre-processing includes receiving one of video frames or image sequences of the image-based data and interactively scrubbing one of the video frames or image sequences; selecting specific frames or sequences of the video frames or image sequences for scene reconstruction; distributed processing of the selected frames or sequences using resource allocation, load balancing, priority-based job queuing, real-time progress monitoring, and interactive progress visualization and status reporting; real-time viewing and editing of the selected frames or sequences to generate photorealistic and editable 3-D scenes, wherein the real-time viewing and editing uses real-time scene exploration and manipulation, camera control and trajectory planning, and arbitrary output variables (AOV) preview capabilities.

In another implementation, a scene reconstruction system for transforming image-based data into photorealistic, editable 3-D scenes is disclosed. The system includes: a pre-processing service to apply transformations and enhancements to the image-based data, to perform computer vision and machine learning algorithms for automated preprocessing tasks; a reconstruction service to implement structure from motion (SfM) and 3-D Gaussian splatting (3-DGS) on the pre-processed image-based data to generate reconstructed 3-D scenes; and a viewer service to enable browser-based interactive viewing and editing of the reconstructed 3-D scenes using tools for scene navigation and editing, including segmentation, object removal, clone stamping, and inpainting to generate the editable 3-D scenes.

Other features and advantages should be apparent from the present description which illustrates, by way of example, aspects of the disclosure.

### BRIEF DESCRIPTION OF THE DRAWINGS

The details of the present disclosure, both as to its structure and operation, may be gleaned in part by study of the appended drawings, in which like reference numerals refer to like parts, and in which:

FIG. 1 is a flow diagram illustrating a reconstruction process using a platform in accordance with one implementation of the present disclosure;

FIG. 2 is a block diagram illustrating a web-based platform in accordance with one implementation of the present disclosure; and

FIG. 3 is a flow diagram of a process for operating the platform through an integrated system of microservices that work together to enable an end-to-end 3-D scene reconstruction in accordance with one implementation of the present disclosure.

### DETAILED DESCRIPTION

As described above, existing approaches to generate a digital representation of a physical environment do not provide for easy transformation of image-based data into photorealistic, editable 3-D scenes.

Certain implementations of the present disclosure provide for a comprehensive platform for transforming image-based data into photorealistic, editable 3-D scenes through advanced reconstruction techniques, supporting diverse applications across Visual Effect/Virtual Production (VFX/VP), gaming, Virtual Reality/Augmented Reality (VR/AR), and other applications. After reading below descriptions, it will become apparent how to implement the disclosure in various implementations and applications. Although various implementations of the present disclosure will be described herein, it is understood that these implementations are presented by way of example only, and not limitation. As such, the detailed description of various implementations should not be construed to limit the scope or breadth of the present disclosure.

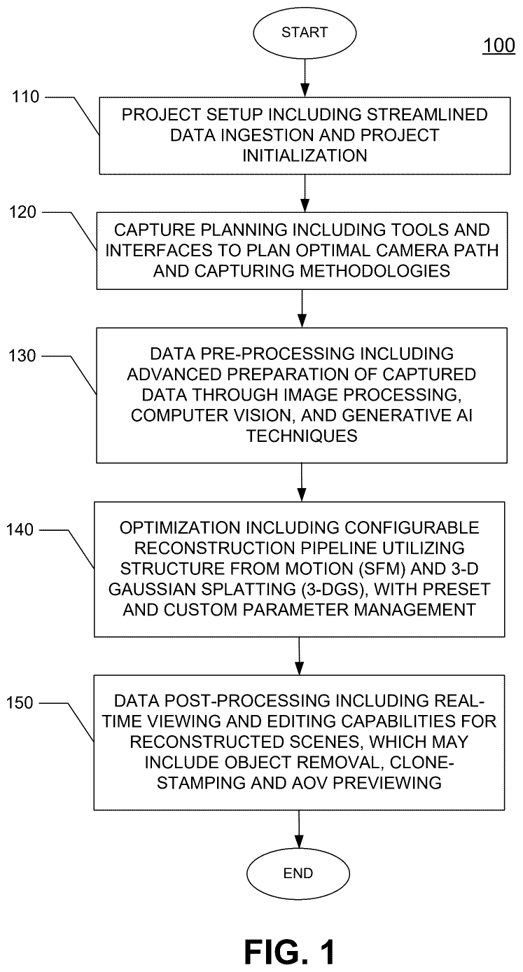

FIG. 1 is a flow diagram illustrating a reconstruction process 100 using a platform in accordance with one implementation of the present disclosure. In one implementation, the platform enables end-to-end management of the reconstruction process from capture planning to final 3-D scene delivery. In the illustrated implementation of FIG. 1, the reconstruction process 100 includes a project setup step 110, a capture planning step 120, a data pre-processing step 130, an optimization step 140, and a data post-processing step 150.

In one implementation, the project setup step 110 includes streamlined data ingestion and project initialization, enabling management and organization of captured data, reconstruction projects, and experiments. In one implementation, the capture planning step 120 includes tools and interfaces to plan optimal camera path and capturing methodologies for both real-world locations and synthetic scenes. In one implementation, the data pre-processing step 130 includes advanced preparation of captured data through image processing, computer vision, and generative AI techniques to optimize input for reconstruction. In one implementation, the optimization step 140 includes configurable reconstruction pipeline utilizing Structure from Motion (SfM) and 3-D Gaussian Splatting (3-DGS), with preset and custom parameter management. In one implementation, the data post-processing step 150 includes real-time viewing and editing capabilities for reconstructed scenes, which includes object removal, clone-stamping and Arbitrary Output Variables (AOV) previewing.

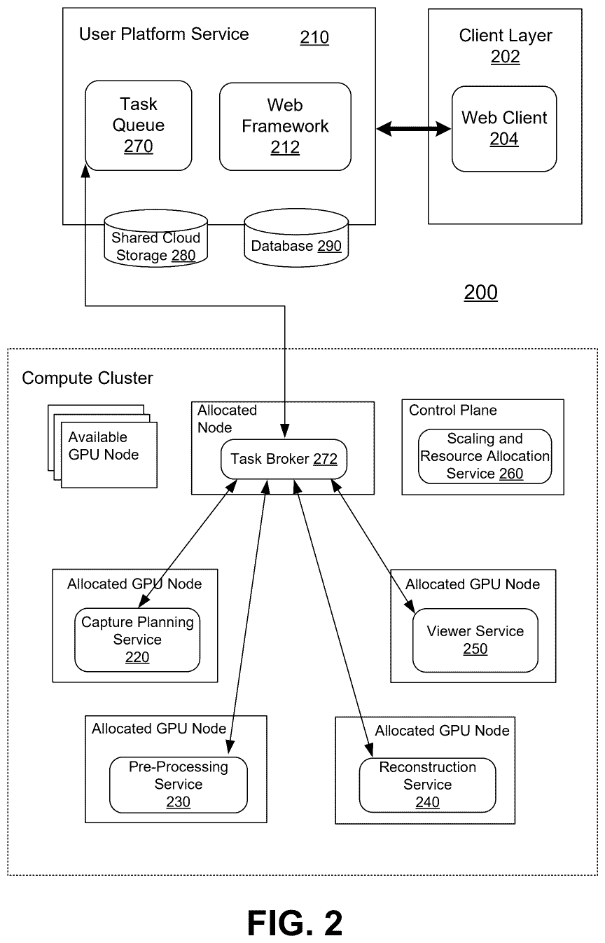

FIG. 2 is a block diagram illustrating a web-based platform 200 in accordance with one implementation of the present disclosure. In one implementation, the platform 200 serves as both a processing engine and marketplace, allowing users to: share reconstructed scenes between users; exchange successful workflow parameters and reconstruction settings; access on-demand, scalable cloud computing resources for rapid processing; and collaborate on scene refinement and optimization. In one implementation, the platform leverages a modular, microservices-based architecture to ensure scalability, flexibility, and reliability.

In the illustrated implementation of FIG. 2, the platform 200 includes a user-facing web application (e.g., user platform service 210), a capture planning microservice (e.g., capture planning service 220), an image pre-processing microservice (e.g., pre-processing service 230), a reconstruction microservice (e.g., reconstruction service 240), a 3-D web-viewer microservice (e.g., viewer service 250), a scaling and resource allocation server (e.g., resource management service 260), a task queue and messaging system 270, a shared storage infrastructure 280, and database systems (e.g., data management service 290). In the illustrated implementation, the user platform service 210 interfaces with a web client 204 of a client layer 202.

In one implementation, the user-facing web application 210 includes a web application framework 212 handling authentication, system administration and process orchestration. In one implementation, the user-facing web application 210: (a) is integrated with distributed task processing for workload management; (b) provides intuitive interfaces for capture planning, data upload, preprocessing, reconstruction parameter setup, and 3-D scene viewing/editing; (c) is deployed using containerized services with centralized container registry and shared storage infrastructure; and (d) communicates with backend services through standardized protocols for real-time updates.

In one implementation, the capture planning service 220: (a) provides tools for path optimization and planning; (b) implements proxy geometry processing; and (c) handles rig configuration management.

In one implementation, the pre-processing service 230: (a) executes on GPU-enabled compute nodes for efficient processing; (b) applies transformations and enhancements to optimize input images for reconstruction; (c) implements computer vision and machine learning algorithms for automated preprocessing tasks; and (d) interfaces with shared storage for data access and persistence.

In one implementation, the reconstruction service 240: (a) executes core reconstruction pipeline on GPU-enabled compute nodes; (b) implements SfM processing pipeline; (c) implements 3-D Gaussian splatting optimization pipeline; (d) supports preset and custom parameter configurations; (e) generates intermediate checkpoints and final reconstructions; and (f) provides progress monitoring and status reporting.

In one implementation, the viewer service 250: (a) executes on GPU-enabled compute nodes for real-time rendering; (b) enables browser-based interactive viewing and editing of reconstructed 3-D scenes; and (c) implements tools for scene navigation and editing, including segmentation, object removal, clone stamping, and inpainting.

In one implementation, the scaling and resource allocation service 260: (a) manages dynamic allocation and scaling of compute resources; (b) implements container orchestration for resource management and availability; (c) ensures optimal workload distribution and performance; (d) controls GPU resource allocation across platform services; and (e) implements fault tolerance and recovery mechanisms.

In one implementation, the task queue and messaging system 270: (a) facilitates asynchronous inter-service communication; (b) manages task prioritization and distribution; (c) provides real-time status updates and notifications; and (d) routes jobs to available GPU nodes using, for example, a task broker 272.

In one implementation, the shared storage infrastructure 280: (a) manages input data, intermediate results, and final reconstructions; (b) provides scalable data access across platform components; (c) implements enterprise-grade storage solutions for data management; and (d) ensures data redundancy and backup capabilities.

In one implementation, the data management service 290: (a) manages application data, user information, and configuration; (b) implements service-specific data stores; (c) ensures data replication and consistency; and (d) provides reliable data access across distributed services.

Accordingly, the above-described services/components work together to provide an end-to-end solution for photorealistic 3-D reconstruction. The modular architecture enables easy maintenance, updates, and integration of new features as the platform evolves. Thus, in one implementation, all components are deployed within secure, isolated environments with appropriate access controls and monitoring systems in place.

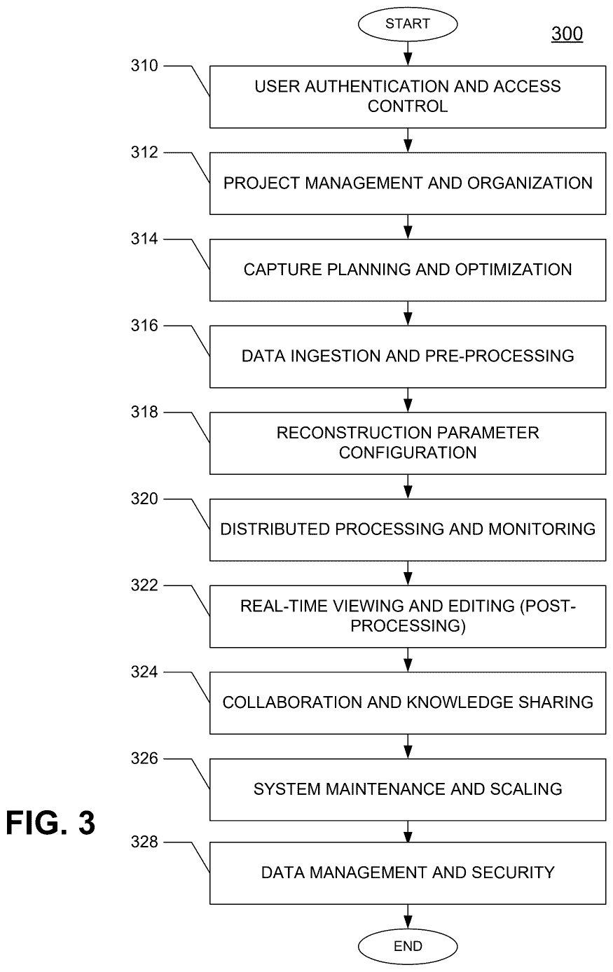

FIG. 3 is a flow diagram of a process 300 for operating the platform through an integrated system of microservices that work together to enable an end-to-end 3-D scene reconstruction in accordance with one implementation of the present disclosure.

In the illustrated implementation of FIG. 3, the process 300 for operating the platform through an integrated system of microservices includes a user authentication and access control step 310, a project management and organization step 312, a capture planning and optimization step 314, a data ingestion and pre-processing step 316, a reconstruction parameter configuration step 318, a distributed processing and monitoring step 320, a real-time viewing and editing step 322, a collaboration and knowledge sharing step 324, a system maintenance and scaling step 326, and a data management and security step 328.

In one implementation, the user authentication and access control step 310 includes: (a) secure user registration and authentication through the web application service; (b) role-based access control system defining user privileges and feature accessibility; and (c) centralized user management and session tracking.

In one implementation, the project management and organization step 312 includes: (a) project creation and management through intuitive web interface; (b) hierarchical organization of projects and experiments; (c) storage and tracking of input media, parameter settings, and reconstruction results; and (d) version control for tracking experiment iterations.

In one implementation, the capture planning and optimization step 314 includes: (a) path optimization utilizing either GPS coordinates for automatic proxy geometry generation or user-provided proxy geometry/3-D models; (b) supports capture planning through (1) digital twin integration of physical camera rigs and (2) capture requirement-based rig recommendations including method selection (drone, car, pedestrian) and time constraint considerations; (c) target zone specification using (1) user-defined “hotspot” zones for focused reconstruction and (2) tools for zone definition; and (d) visualization of planned camera paths and positions.

In one implementation, the data ingestion and pre-processing step 316 includes ingesting the image-based data from the user for processing. The data ingestion and pre-processing step 316 also includes: (a) data upload and organization through storage service; (b) media preview functionality including (1) interactive scrubbing through video frames or image sequences and (2) selection tools for choosing specific frames for reconstruction; and (c) GPU-accelerated pre-processing pipeline offering including (1) automated image transformation tools (scaling, rotation, translation), (2) batch processing capabilities for large datasets, (3) computer vision-based object detection and segmentation, and (4) AI-powered image enhancement and optimization. In one implementation, scrubbing video frames or image sequence refers to a process of manually navigating through a video by dragging a slider or timeline, allowing users to quickly preview and find specific points within the video.

In one implementation, the reconstruction parameter configuration step 318 includes: (a) interface for reconstruction setup via web application service; (b) configurable optimization parameters including (1) curated parameter presets based on validated workflows, (2) advanced customization options for SfM and 3-DGS pipelines, and (3) user-defined preset creation and sharing.

In one implementation, the distributed processing and monitoring step 320 includes: (a) job distribution through dispatch service including (1) resource allocation and load balancing, (2) priority-based job queuing, (3) real-time progress monitoring, and (4) checkpoint generation; (b) fault-tolerant processing with automatic recovery; and (c) interactive progress visualization and status reporting.

In one implementation, the real-time viewing and editing (post-processing) step 322 includes combining the output of steps 316-320 to generate draft photorealistic, editable 3-D scenes. The step 322 also includes reviewing the draft photorealistic, editable 3-D scenes to generate the final photorealistic, editable 3-D scenes, which includes using: (a) GPU-accelerated 3-D viewer powered by dedicated viewer service including (1) real-time scene exploration and manipulation, (2) advanced camera control and trajectory planning, and (3) arbitrary output variables (AOV) preview capabilities; (b) comprehensive editing toolkit including (1) object segmentation, (2) context-aware clone stamping, and (3)inpainting; and (c) scene export in industry-standard formats.

In one implementation, the collaboration and knowledge sharing step 324 includes: built-in collaboration features including (1) secure scene sharing between users, (2) parameter preset exchange, and (3) workflow documentation and best practices.

In one implementation, the system maintenance and scaling step 326 includes: resource management through dedicated service including (1) dynamic scaling of compute resources, (2) GPU allocation optimization, and (3) performance monitoring.

In one implementation, the data management and security step 328 includes: (a) storage infrastructure: (1) distributed data storage with redundancy, (2) automated backup systems, and (3) access control and audit logging; and (b) database management system for application data.

The platform's modular architecture enables seamless integration of new features and technologies while maintaining high performance and reliability. Each component is designed to scale independently, allowing the system to efficiently handle varying workloads while providing a smooth user experience.

While the platform is designed as a cloud-based, micro-services driven solution, three fundamental alternative approaches may include: a desktop application; a hybrid cloud-local architecture; and a decentralized architecture.

In one implementation, the desktop application: (a) includes package complete workflow as standalone software including project creation, data offloading, capture planning, preprocessing, reconstruction pipeline (SfM, 3-DGS), and post-processing (viewing/editing); (b) enables end-to-end local processing without cloud dependency; (c) significantly limits multi-GPU processing capabilities and collaborative features; (d) restricted by local compute resources and storage capacity; and (e) challenges in maintaining workflow consistency across installations.

In one implementation, the hybrid cloud-local architecture: (a) distributes workload between local and cloud resources including local handling of capture planning and initial preprocessing, cloud managing heavy computation and storage; (b) balances resource utilization while maintaining workflow integrity; (c) requires sophisticated data synchronization and workflow orchestration; (d) suitable for organizations with significant local infrastructure; and (e) complexity in managing hybrid resource allocation.

In one implementation, the fully decentralized architecture: (a) distributes entire reconstruction workflow across peer-to-peer network; (b) enables community-driven resource sharing and marketplace functionality; (c) introduces significant challenges in coordinating complex multi-stage workflows; (d) requires robust mechanisms for maintaining processing standards; and (e) faces technical limitations for production deployment.

While these alternatives offer different approaches to implementing the complete reconstruction workflow, the current cloud-based architecture provides balance of scalability, accessibility, and collaborative potential for most use cases.

The platform introduces innovative features that advance beyond existing 3-D reconstruction solutions including (a) comprehensive web-based integration, (b) real-time Gaussian splat manipulation, (c) parameter management and experimentation, and (d) capture planning integration.

In one implementation, (a) the comprehensive web-based integration includes (1) integration of the entire reconstruction pipeline in a browser-based platform including: seamless connection between capture planning, data ingestion, processing, reconstruction, and editing; unified project management tracking full workflow history and parameters; elimination of multiple specialized software tools typically required; and cloud-based architecture; and (2) novel marketplace approach combining including: reconstructed scene cataloging and sharing; and parameter preset exchange O Workflow documentation and best practices.

In one implementation, the real-time Gaussian splat manipulation includes: (1) first implementation of semantic and 3-D-aware object selection in Gaussian splatting including: novel single-pointer selection triggering 3-D-aware object identification; integration with high-quality 2D segmentation model backends for selection refinement; advanced editing capabilities such as shape-aware selection and manipulation, object dragging with 3-D position awareness, object cloning and placement, and object removal; real-time navigation and visualization such as color, depth, and normal representation toggling, adjustable color complexity levels, and virtual camera manipulation and rendering; and preservation of edited changes in original format.

In one implementation, the parameter management and experimentation includes: (1) novel unified interface for managing complex reconstruction parameters including: library of validated parameter presets for different reconstruction scenarios; direct connection between parameter configurations and reconstruction results; quick comparison capabilities between different parameter sets; and preset sharing enabling knowledge transfer between users; and (2) Streamlined experimentation workflow including: single environment for parameter adjustment and result evaluation; faster prototyping through immediate feedback; tracked relationship between configurations and outcomes; and replication support through complete parameter capture.

In one implementation, the capture planning integration includes: (1) novel integration of capture planning within reconstruction workflow including: advanced camera path optimization through either such as GPS coordinates for automatic proxy geometry generation, and user-provided proxy geometry/3-D models for target zones; capture methodology support such as digital twin integration of physical camera rigs, requirement-based rig recommendations (drone, car, pedestrian) based on time constraints and capture method preferences; target zone specification such as user-defined “hotspot” zones for focused reconstruction and tools for zone definition; support for both real-world and synthetic scene capture; and optimization for minimal camera positions.

These innovations work together to create a unique platform that significantly advances the efficiency and accessibility of professional-quality 3-D reconstruction while maintaining high standards for final output quality.

Advantages of implementations may include one or more of: (a) end-to-end Integration including: browser-based platform unifying the complete reconstruction workflow; eliminates need for multiple specialized software tools as it enables direct progression from capture through editing; maintains technical depth while simplifying complex processes; and enables collaboration through asset/preset sharing; (b) Real-time Viewing and Editing including: interactive Gaussian splat visualization; semantic and 3-D-aware object selection; object removal and clone stamping; and scene editing tools preserve reconstruction quality; (c) parameter management including: unified interface for reconstruction parameters; library of validated parameter presets; experiment tracking and version control; and parameter sharing between users; and (d) intelligent capture planning including: automated path optimization reduces capture time; integrated rig recommendations; target zone specification improves efficiency; and supports both real-world and synthetic scenes.

In a particular implementation, a scene reconstruction method using image-based data is disclosed. The method includes: data ingesting and pre-processing of the image-based data entered by a user, wherein the pre-processing includes receiving one of video frames or image sequences of the image-based data and interactively scrubbing one of the video frames or image sequences; selecting specific frames or sequences of the video frames or image sequences for scene reconstruction; distributed processing of the selected frames or sequences using resource allocation, load balancing, priority-based job queuing, real-time progress monitoring, and interactive progress visualization and status reporting; real-time viewing and editing of the selected frames or sequences to generate photorealistic and editable 3-D scenes, wherein the real-time viewing and editing uses real-time scene exploration and manipulation, camera control and trajectory planning, and arbitrary output variables (AOV) preview capabilities.

In one implementation, the method further includes authenticating the user to control access through a web application service. In one implementation, the user is authenticated using centralized user management and session tracking. In one implementation, the access is controlled using a role-based access control system defining user privileges and feature accessibility. In one implementation, the method further includes creating and managing a project for the scene reconstruction through an intuitive web interface. In one implementation, the project is hierarchically organized and includes tracking of input media, parameter settings, and results of the scene reconstruction. In one implementation, the method further includes storing and tracking the image-based data, parameter settings, and reconstruction results. In one implementation, the method further includes performing capture planning and optimization on the image-based data including path optimization utilizing one of GPS coordinates for automatic proxy geometry generation or user-provided proxy geometry/3-D models. In one implementation, the capture planning comprises digital twin integration of physical camera rigs and capture requirement-based rig recommendations including method selection and time constraint considerations. In one implementation, the capture planning comprises a target zone specification using user-defined “hotspot” zones for focused reconstruction and tools for zone definition. In one implementation, the capture planning comprises visualization of planned camera paths and positions. In one implementation, the method further includes performing GPU-accelerated pre-processing including computer vision-based object detection and segmentation. In one implementation, the method further includes performing AI-powered image enhancement and optimization. In one implementation, the method further includes configuring reconstruction parameters by performing advanced customization for structure from motion (SfM) and 3-D Gaussian splatting (3-DGS). In one implementation, the method further includes collaborating and sharing knowledge including secure scene sharing between users, parameter preset exchange, and workflow documentation.

In another particular implementation, a scene reconstruction system for transforming image-based data into photorealistic, editable 3-D scenes is disclosed. The system includes: a pre-processing service to apply transformations and enhancements to the image-based data, to perform computer vision and machine learning algorithms for automated preprocessing tasks; a reconstruction service to implement structure from motion (SfM) and 3-D Gaussian splatting (3-DGS) on the pre-processed image-based data to generate reconstructed 3-D scenes; and a viewer service to enable browser-based interactive viewing and editing of the reconstructed 3-D scenes using tools for scene navigation and editing, including segmentation, object removal, clone stamping, and inpainting to generate the editable 3-D scenes.

In one implementation, the system is applied in at least one of visual effect/virtual production (VFX/VP), gaming, and virtual reality/augmented reality (VR/AR). In one implementation, the system further includes: a capture planning service to: provide tools for path optimization and planning; implement proxy geometry processing; and perform rig configuration management. In one implementation, the system further includes: a scaling and resource allocation service to: manage dynamic allocation and scaling of compute resources; implement container orchestration for resource management and availability; control GPU resource allocation across platform services; and implement fault tolerance and recovery mechanisms. In one implementation, the system further includes: a task queue and messaging service to: enable asynchronous inter-service communication; manage task prioritization and distribution; provide real-time status updates and notifications; and route jobs to available GPU nodes. In one implementation, the system further includes: a data management service to: manage application data, user information, and configuration; implement service-specific data stores; enable data replication and consistency; and provide reliable data access across distributed services.

The description herein of the disclosed implementations is provided to enable any person skilled in the art to make or use the present disclosure. Numerous modifications to these implementations would be readily apparent to those skilled in the art, and the principals defined herein can be applied to other implementations without departing from the spirit or scope of the present disclosure. Thus, the present disclosure is not intended to be limited to the implementations shown herein but is to be accorded the widest scope consistent with the principal and novel features disclosed herein.

All features of each above-discussed example are not necessarily required in a particular implementation of the present disclosure. Further, it is to be understood that the description and drawings presented herein are representative of the subject matter that is broadly contemplated by the present disclosure. It is further understood that the scope of the present disclosure fully encompasses other implementations that may become obvious to those skilled in the art and that the scope of the present disclosure is accordingly limited by nothing other than the appended claims.

1. A scene reconstruction method using image-based data, the method comprising:
data ingesting and pre-processing of the image-based data entered by a user,
wherein the pre-processing includes receiving one of video frames or image sequences of the image-based data and interactively scrubbing one of the video frames or image sequences;
selecting specific frames or sequences of the video frames or image sequences for scene reconstruction;
distributed processing of the selected frames or sequences using resource allocation, load balancing, priority-based job queuing, real-time progress monitoring, and interactive progress visualization and status reporting;
real-time viewing and editing of the selected frames or sequences to generate photorealistic and editable 3-D scenes,
wherein the real-time viewing and editing uses real-time scene exploration and manipulation, camera control and trajectory planning, and arbitrary output variables (AOV) preview capabilities.

2. The method of claim 1, further comprising
authenticating the user to control access through a web application service.

3. The method of claim 2, wherein the user is authenticated using centralized user management and session tracking.

4. The method of claim 2, wherein the access is controlled using a role-based access control system defining user privileges and feature accessibility.

5. The method of claim 1, further comprising
creating and managing a project for the scene reconstruction through an intuitive web interface.

6. The method of claim 5, wherein the project is hierarchically organized and includes tracking of input media, parameter settings, and results of the scene reconstruction.

7. The method of claim 5, further comprising
storing and tracking the image-based data, parameter settings, and reconstruction results.

8. The method of claim 1, further comprising
performing capture planning and optimization on the image-based data including path optimization utilizing one of GPS coordinates for automatic proxy geometry generation or user-provided proxy geometry/3-D models.

9. The method of claim 8, wherein the capture planning comprises digital twin integration of physical camera rigs and capture requirement-based rig recommendations including method selection and time constraint considerations.

10. The method of claim 8, wherein the capture planning comprises a target zone specification using user-defined “hotspot” zones for focused reconstruction and tools for zone definition.

11. The method of claim 8, wherein the capture planning comprises visualization of planned camera paths and positions.

12. The method of claim 1, further comprising
performing GPU-accelerated pre-processing including computer vision-based object detection and segmentation.

13. The method of claim 1, further comprising
performing AI-powered image enhancement and optimization.

14. The method of claim 1, further comprising
configuring reconstruction parameters by performing advanced customization for structure from motion (SfM) and 3-D Gaussian splatting (3-DGS).

15. The method of claim 1, further comprising
collaborating and sharing knowledge including secure scene sharing between users, parameter preset exchange, and workflow documentation.

16. A scene reconstruction system for transforming image-based data into photorealistic, editable 3-D scenes, the system comprising:
a pre-processing service to apply transformations and enhancements to the image-based data, to perform computer vision and machine learning algorithms for automated preprocessing tasks;
a reconstruction service to implement structure from motion (SfM) and 3-D Gaussian splatting (3-DGS) on the pre-processed image-based data to generate reconstructed 3-D scenes; and
a viewer service to enable browser-based interactive viewing and editing of the reconstructed 3-D scenes using tools for scene navigation and editing, including segmentation, object removal, clone stamping, and inpainting to generate the editable 3-D scenes.

17. The system of claim 16, wherein the system is applied in at least one of visual effect/virtual production (VFX/VP), gaming, and virtual reality/augmented reality (VR/AR).

18. The system of claim 16, further comprising:
a capture planning service to:
provide tools for path optimization and planning;
implement proxy geometry processing; and
perform rig configuration management.

19. The system of claim 16, further comprising:
a scaling and resource allocation service to:
manage dynamic allocation and scaling of compute resources;
implement container orchestration for resource management and availability;
control GPU resource allocation across platform services; and
implement fault tolerance and recovery mechanisms.

20. The system of claim 16, further comprising:
a task queue and messaging service to:
enable asynchronous inter-service communication;
manage task prioritization and distribution;
provide real-time status updates and notifications; and
route jobs to available GPU nodes.

21. The system of claim 16, further comprising:
a data management service to:
manage application data, user information, and configuration;
implement service-specific data stores;
enable data replication and consistency; and
provide reliable data access across distributed services.
